(19) United States
(12) Patent Application Publication
(10) Pub. No.: US 2025/0137374 A1
(43) Pub. Date: May 1, 2025

(54) METHOD FOR BALANCING TURBINE WHEELS OF EXHAUST GAS TURBINES, AND BALANCED TURBINE WHEEL

(71) Applicant: ACCELLERON SWITZERLAND LTD., Baden (CH)

(72) Inventors: Nico GEIST, Bernau im Schwarzwald (DE); Stephan SENN, Remigen (CH); Frank BURGER, Obermettingen (DE)

(21) Appl. No.: 18/561,183

(22) PCT Filed: May 18, 2022
(86) PCT No.: PCT/EP2022/063443

§ 371 Date: May 9, 2024

(30) Foreign Application Priority Data
May 18, 2021 (EP) 21174375.2

(51) Int. Cl. F01D 5/02; G01M 1/34

(52) U.S. Cl. CPC F01D 5/027; G01M 1/34; F05D 2220/40; F05D 2230/10; F05D 2260/15

(57) ABSTRACT

A method for balancing turbine wheels (10) of exhaust gas turbines and a balanced turbine wheel (10) are described herein. A turbine wheel of an exhaust gas turbine has a hub rear wall (15) which faces away from the fluid flow region and has a mass-removal indentation (13) and a marking bead (16).

### TECHNICAL FIELD

The present disclosure concerns a method for balancing turbine wheels of exhaust gas turbines by creating a mass-removal region of defined shape and position in the hub rear wall of a turbine wheel of an exhaust gas turbine, and a balanced turbine wheel for exhaust gas turbines.

### TECHNICAL BACKGROUND

Exhaust gas turbines are used in order to utilize the energy contained in the exhaust gas. To extract energy from the exhaust gas stream, turbine wheels of an exhaust gas turbine are used which are located in the exhaust gas stream and have a fluid-mechanically optimized shape. The turbine wheel is here arranged on a shaft and mounted thereby so as to be rotatable about a rotational axis.

Because of the high rotational speeds of turbine wheels of exhaust gas turbines and their position in the exhaust gas tract, turbine wheels are components of exhaust gas turbines which are under high thermal and mechanical load. Above all, the mechanical load within a turbine wheel of an exhaust gas turbine is huge, and largely results from the high rotational speeds and associated centrifugal forces. Deviations in the mass distribution over the circumference of a turbine wheel, which disrupt the roundness of the turbine wheel and potentially can generate additional loads, play a predominant role here. The mass unevenly distributed over the circumference, known as imbalance, is therefore actively countered both by structural measures and by subsequent machining of a turbine wheel of an exhaust gas turbine.

In the prior art, to reduce the imbalance of a turbine wheel of an exhaust gas turbine, typically a balancing rim is provided on the hub rear wall. The balancing rim takes the form of a convex bead running in the circumferential direction on the hub rear wall. During a balancing process, the balancing rim may be removed in defined fashion and hence an even distribution of masses in the circumferential direction of the turbine wheel of an exhaust gas turbine can be achieved. It is known here to remove the balancing rim using a planar grinding process.

The balancing rim to be provided for the balancing process however has disadvantages in many respects. These include but are not limited to the provision, design and calculation of additional components (and hence masses) in a turbine wheel of an exhaust gas turbine, additional machining steps required in the production process, and negative effects on the internal load distribution and stresses of a turbine wheel of an exhaust gas turbine. The additional application of masses to a turbine wheel of an exhaust gas turbine rotating at high-speed, which creates additional centrifugal forces, and the disadvantageous characteristic of a balancing rim, are harmful to the mechanical stresses within a turbine wheel of an exhaust gas turbine. Therefore a balancing rim also has a disadvantageous effect on the cycling capacity, and here in particular on the cycling capacity with respect to low-cycle fatigue, also known as low-cycle capacity.

In view of the above statements, there is a need for a method for balancing a turbine wheel of an exhaust gas turbine which may at least partially reduce the above-mentioned disadvantages, and a correspondingly balanced turbine wheel. US 2020/392 848 A1 describes an exhaust gas turbocharger wheel with a hub which has a lug, a rear disc with a shaft connecting portion, a rotational axis and blades extending from the hub so as to define the exhaust gas flow channel. U.S. Pat. No. 8,936,439 B3 describes a turbine wheel which is arranged around a shaft and has a rear side with separator arranged thereon, an inner undercut arranged between the separator and the shaft, and an outer undercut between the separator and the outer circumference assigned to the rear side.

### BRIEF PRESENTATION OF THE INVENTION

This object is achieved by a method for balancing a turbine wheel according to claim 1. The object is furthermore achieved by a turbine wheel according to claim 8, and an exhaust gas turbine according to claim 12. Further embodiments, modifications and improvements arise from the following description and the appended claims.

According to one aspect of the invention, a method is provided for balancing a turbine wheel for an exhaust gas turbine. The turbine wheel is rotatable about its rotational axis and has a hub and a plurality of turbine blades attached to the hub and arranged in a fluid flow region. The hub has a hub rear wall facing away from the fluid flow region with a marking bead running concentrically about the rotational axis. The method comprises:
movement of an ellipsoidal material-removal tool relative to the turbine wheel at a mass-removal position next to the marking bead;
creation of a mass-removal indentation, asymmetric relative to the rotational axis, in the hub rear wall for balancing the turbine wheel by removal, by means of the material-removal tool, of hub material of the hub rear wall, next to the marking bead and leaving the marking bead intact.

According to one aspect of the invention, a turbine wheel is provided for an exhaust gas turbine, wherein the turbine wheel is rotatable about its rotational axis and has a hub and a plurality of turbine blades attached to the hub and arranged in the fluid flow region, wherein the hub has a hub rear wall facing away from the fluid flow region. A mass-removal indentation, asymmetric relative to the rotational axis, is provided in the hub rear wall for balancing the turbine wheel. The mass-removal indentation is configured as a concave depression in the hub rear wall with a cross-sectional contour in the form of an ellipse segment, wherein the cross-sectional contour is defined in a cross-sectional plane Z-Z containing the rotational axis. The hub rear wall furthermore has a marking bead running concentrically to the rotational axis, wherein the marking bead and the mass-removal indentation are adjacent to one another without radially overlapping.

As the mass-removal indentation is configured as a concave depression in the hub rear wall, according to a preferred aspect of the invention, no balancing rim is required on the hub rear wall. In particular, after balancing, the hub rear wall may be free from rotationally asymmetrical convex protrusions. Thus the rotating mass and the inertia of the hub can be reduced. A reduced inertia may contribute to better acceleration behavior of the rotor. Because of the cross-sectional contour of the mass-removal indentation in the form of an ellipse segment, the stress on the hub may be further reduced and additional load avoided.

### BRIEF DESCRIPTION OF THE FIGURES

The invention is explained in more detail below with reference to embodiments which do not restrict the scope of protection defined by the claims.

The attached drawings illustrate embodiments and, together with the description, serve to explain the principles of the invention. The elements of the drawings are relative to one another and not necessarily true to scale. The same reference signs designate similar components.

In the figures:

FIG. 1: shows a top view of the hub rear wall (15) of a turbine wheel (10) of an exhaust gas turbine according to one embodiment;

FIG. 2: shows a radial cross-section along the cross-sectional plane Z-Z of the turbine wheel (10) from FIG. 1;

FIG. 3: shows a radial cross-section as in FIG. 2 with geometric dimensions of the individual (part) components;

FIG. 4: shows a detail view of the cross-section of FIG. 2; and

FIG. 5: shows a radial cross-section along the cross-sectional plane Z-Z of the turbine wheel (10) during performance of the method according to one embodiment of the invention.

### DETAILED DESCRIPTION OF THE FIGURES

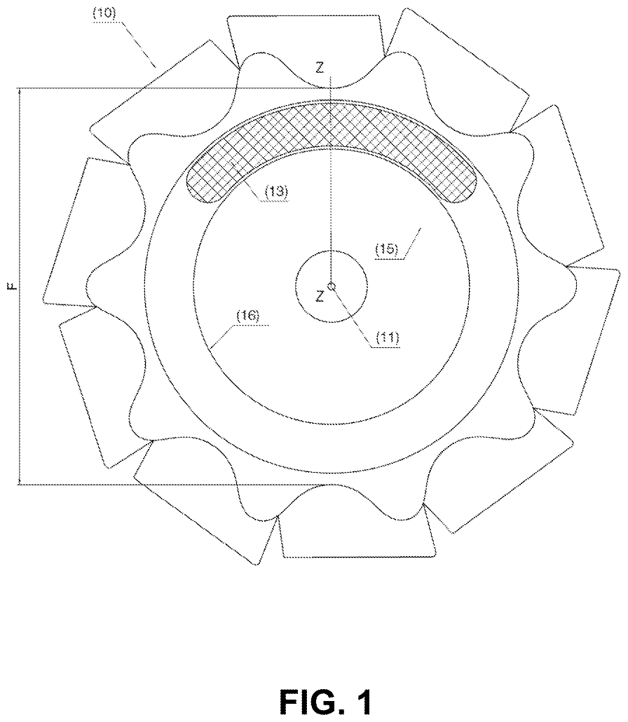

With reference to FIGS. 1 to 4, a turbine wheel (10) of an exhaust gas turbine according to one embodiment is now described. The turbine wheel (10) is rotatable about its rotational axis (11).

FIG. 1 shows a schematic top view of the hub rear wall (15) of a turbine wheel (10) of an exhaust gas turbine according to one embodiment. The turbine wheel (10) has been balanced using the method described herein. The drawing shows a design of the hub rear wall (15) with scallop (undulating edge) on the radially outer rim of the hub rear wall (15) of a turbine wheel (10) of an exhaust gas turbine. The design with scallop is not absolutely essential, and alternatively the hub rear wall could also be circular for example.

Radially outside the hub (12), the drawing shows schematically a plurality of turbine blades which are attached to the hub (12) and arranged in a fluid flow region (14).

The hub rear wall (15) furthermore has a marking bead (16) which is arranged rotationally symmetrically about the rotational axis (11) and concentrically to the rotational axis (11). The marking bead (16) may be arranged at any radial position on the hub rear wall (15), preferably in the radially outer half of the hub rear wall (15), particularly preferably in the radially outer third. The marking bead may here form a protrusion above the base surface of the hub rear wall (15) and hence protrude beyond this in the axial direction.

Furthermore, the hub rear wall (15) has a mass-removal indentation (13). The mass-removal indentation (13) is configured as an arc running around the rotational axis (11). The mass-removal indentation (13) thus runs concentrically to the marking bead (16) which serves as a visual reference. The mass-removal indentation (13) is not rotationally symmetrical but angularly, in the circumferential direction, covers only part of the hub rear wall, maximally an angular region of 180°, i.e. maximally half of the hub rear wall (15). The mass-removal indentation (13) serves for balancing of the turbine wheel (10) and its dimensions are configured depending on the imbalance determined.

The mass-removal indentation (13) runs directly adjacent to the marking bead (16), radially outside the marking bead (16). The mass-removal indentation (13) extends in the radially outer half of the hub rear wall (15), preferably in the radially outer third. The marking bead (16) may be radially spaced from the mass-removal indentation (13).

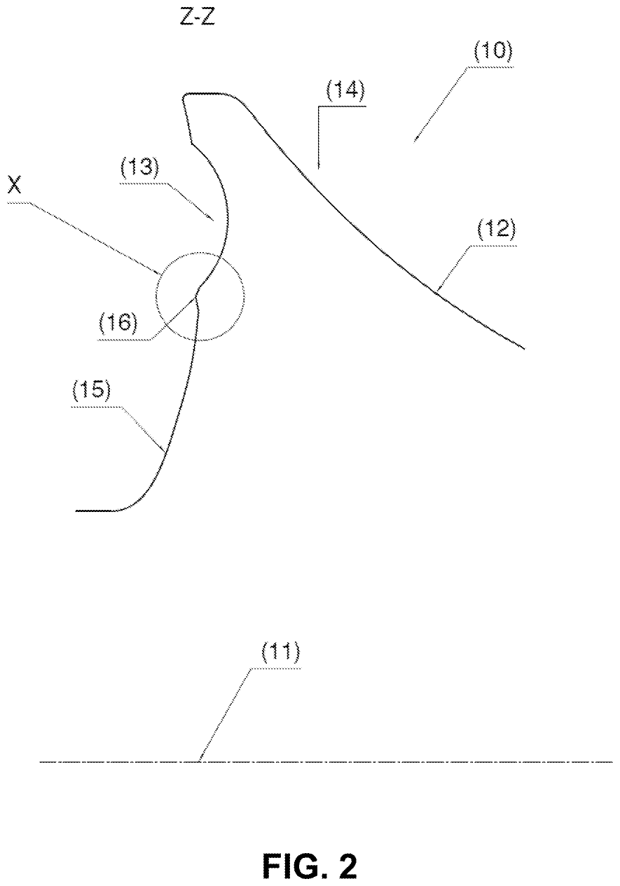

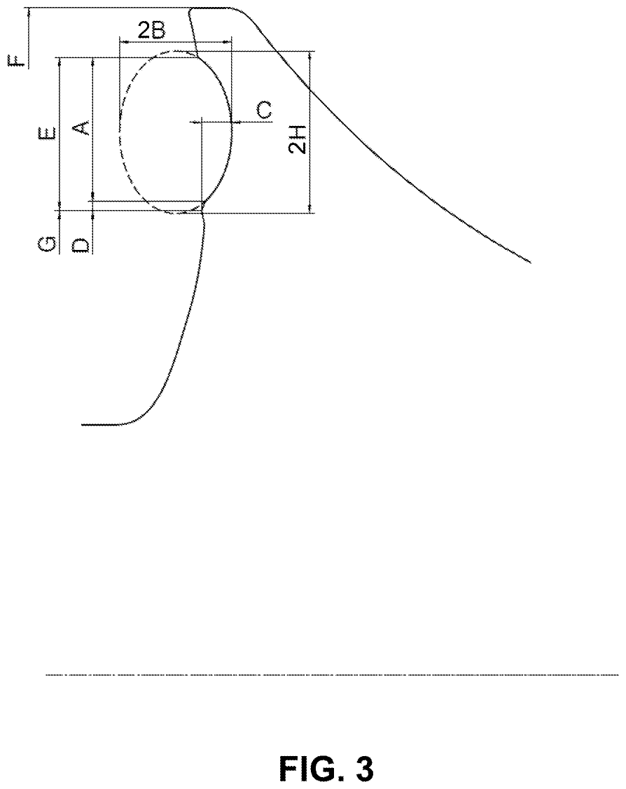

FIGS. 2 and 3 show a cross-sectional view of the turbine wheel (10) of FIG. 1, wherein the cross-sectional plane Z-Z contains the rotational axis (11). The drawing shows the turbine wheel (10), rotatable about the rotational axis (11), with hub (12). On the front side of the hub (12) is a fluid flow region (14) of the turbine wheel (10), wherein the turbine blades arranged on the hub (12) in the fluid flow region (14) are not shown. The cross-sectional contour of the mass-removal indentation (13) and the cross-sectional contour of marking bead (16) can be seen in the hub rear wall (15).

FIG. 3 shows the same cross-sectional view as FIG. 2 with some geometric dimensions marked therein. F indicates the diameter of the rear wall of the turbine wheel (10). The diameter F of a turbine wheel (10) of an exhaust gas turbine, for a non-circular rear wall, is defined as the smallest diameter running through the axis, i.e. with respect to the radially innermost extent of the hub rear wall. If a scallop is provided as illustrated in FIG. 1, the diameter F thus refers to the radially innermost (smallest) diameter of the hub (12). In the embodiment of FIG. 1, this is the radius in the cross-sectional plane Z-Z. In an alternative embodiment (not shown), there is no scallop and the hub rear wall is circular with constant diameter F.

FIG. 3 also shows the geometric dimensions and relations of parts of the hub rear wall (15), and in particular the mass-removal indentation (13) provided therein. The mass-removal indentation (13) is designed in cross-section as a segment of an ellipse, wherein H designates the large semi-axis of the ellipse and B the small semi-axis of the ellipse. The penetration depth C of the mass-removal indentation (13) constitutes the depth of penetration of the ellipse into the hub rear wall (15). C is here defined more precisely is the deepest penetration depth relative to the contour of the hub rear wall (15) without mass-removal indentation (13). This contour without mass-removal indentation (13) is evident from a cross-section of part of the hub rear wall without mass-removal indentation, such as a cross-section on the side of the hub rear wall (15) opposite the cross-section Z-Z, i.e. as a mirror image about the axis (11) in FIG. 1.

Furthermore, FIG. 3 shows the marking bead (16). Unless specified otherwise, all positional data concerning the marking bead (16) refer to the apex of the marking bead (16). The marking bead apex diameter G is thus for example defined as the diameter of the apex of the marking bead (16). The marking bead (16), or more precisely its apex, is radially spaced from the mass-removal indentation (13), wherein D indicates the radial distance between the apex of the marking bead (16) and the nearest (here: radially inner) limit of the mass-removal indentation (13). The radial distance between the apex of the marking bead (16) and the furthest (here: radially outer) limit of the mass-removal indentation (13) is designated E. The mass-removal indentation (13) has a radial extent A from the radially inner limit to the radially outer limit. The ellipsoidal mass-removal indentation (13) is defined by an ellipse, wherein the ellipse has a large semi-axis H and a small semi-axis B. The penetration depth of the mass-removal indentation (13) is marked C. Furthermore, F designates the diameter of the rear wall of the turbine wheel (10) of an exhaust gas turbine.

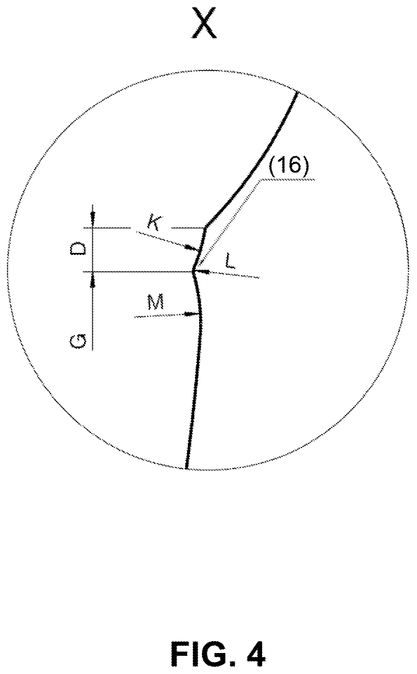

FIG. 4 shows a detail view of FIG. 2 and FIG. 3 and contains an enlarged view of the marking bead (16) and the nearest (radially inner) limit of the mass-removal indentation (13) with distance D in between. The curvature radii K, L, M define the marking bead (16) geometrically. K indicates the concave curvature radius of the transition between the apex of the marking bead (16) and the radially inner limit of the mass-removal indentation (13), L the convex curvature radius of the transition at the apex of the marking bead (16), and M the concave curvature radius of the transition from the apex of the marking bead (16) to the region of the hub rear wall (15) lying radially inside the marking bead (16). The curvature radius L may also be L=0, which corresponds to a sharp edge.

FIG. 4 furthermore shows that the marking bead (16) is produced as a convex protrusion in and relative to the hub rear wall (15), wherein the marking bead (16) is geometrically defined by the curvature radii K, L, M.

As shown in FIG. 1, all elements of the hub rear wall-with the exception of the mass-removal indentation (13)-illustrated in FIGS. 2 and 3 run around the rotational axis (11) in the figures.

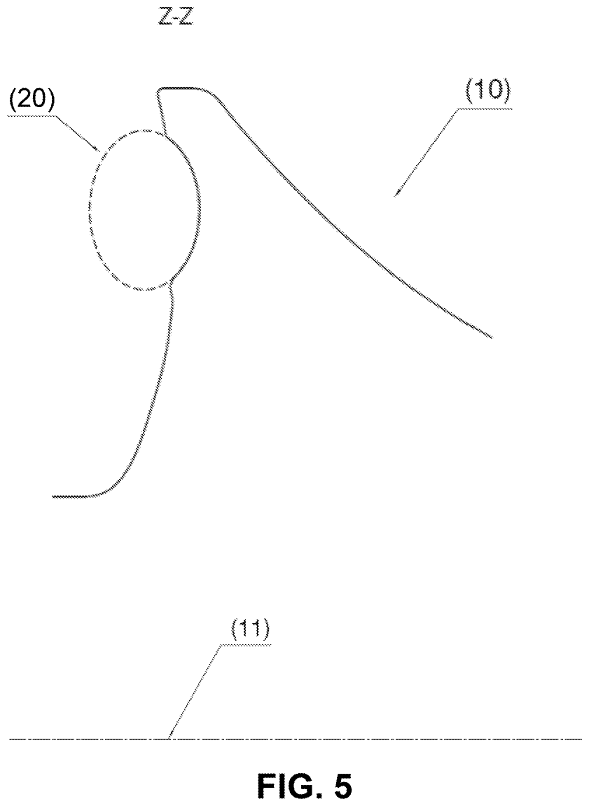

FIG. 5 illustrates a method for balancing a turbine wheel (10) for or of an exhaust gas turbine. The starting point of the method is the turbine wheel (10) of FIGS. 1 to 4, still without mass-removal indentation (13). According to the method, firstly the imbalance is determined in the known fashion, e.g. by assessing the imbalance of the rotating turbine wheel (10).

Depending on the determined imbalance of the turbine wheel (10), a material-removal profile is determined for the mass-removal indentation (13). This material-removal profile indicates how the material should be removed and may for example be parameterized by the angular extent (start and end angle) and the penetration depth of a mass-removal indentation (13) to be produced. The material-removal profile and resulting mass-removal indentation (13) are asymmetric with respect to the rotational axis (11) so as to compensate for imbalance.

The mass-removal indentation (13) is then made in the hub rear wall following the material-removal profile by means of an ellipsoidal material-removal tool (20) illustrated in FIG. 5. The mass is removed at the mass-removal positions by a relative movement of the tool (20) and hub rear wall (15), i.e. for example by moving the tool (20) relative to a stationary hub rear wall (15). The shape and movement of the ellipsoidal material-removal tool (20) define the form of the mass-removal indentation (13).

The movement of the tool (20) and hence the position of the mass-removal indentation (13) are here oriented relative to the marking bead (16), i.e. next to and along the marking bead (16), wherein the marking bead (16) is left intact. The marking bead thus allows a precise orientation for producing the mass-removal indentation (13) at a defined point in the hub rear wall (15). Thus, during the process, it can be ensured that the radially inner region of the hub rear wall (15) (radially inside the marking bead (16)), which is mechanically heavily loaded or has mechanical stress maxima, is not adversely affected. In addition, a visual inspection is possible after balancing. Balancing in the region radially smaller than the marking bead (16) could lead to mechanical limitations with respect to low-cycle fatigue of the turbine wheel (10). Preferably, the radial distance of the tool (20) from the marking bead (16) does not change during the movement.

The ellipsoidal material-removal tool (20) is here depicted schematically as a grinding tool with ellipsoidal grinding head, wherein the ellipsoidal grinding head rotates for example about an axis running in the radial direction. Also, in alternative embodiments, another possibly sloping rotational axis is possible. In the case of a spherical material-removal tool such as a spherical grinding head, the rotational axis is freely variable.

The method may optionally comprise at least one further determination of the (remaining) imbalance, and adaptation or addition to the mass-removal indentation (13) according to the above-described steps.

### Description of Further Details, Possible Variants and General Aspects

Possible variants and general optional aspects of the invention are described below. Here, unless excluded, any aspect may be combined with any other aspect of the invention. The aspects are also designated embodiments and partially illustrated by reference signs which refer to the elements illustrated in the above-described figures, without however being restricted to the embodiments shown therein in any further respect.

Aspects of a method for balancing a turbine wheel (10) for or of an exhaust gas turbine are first described below. The turbine wheel (10) of the exhaust gas turbine is mounted rotatably and rotates about its rotational axis (11). The turbine wheel (10) has a hub (12) and a plurality of turbine blades attached to the hub (12) and arranged in a fluid flow region (14). The fluid flow region (14) is the region in which the fluid, in particular exhaust gas, flows onto the turbine blades and thus performs work. The hub (12) also has a hub rear wall (15) facing away from the fluid flow region (14). The hub rear wall (15) is thus arranged on a side of the hub (12) facing away from the fluid flow region (14), i.e. opposite this. This does not however exclude the possibility of fluid also coating the hub rear wall (15). The hub rear wall (15) is preferably free from turbine blades and/or may extend in a preferably radial direction (e.g. with an angular deviation of maximum 40° from the radial plane). The hub rear wall (15) has a marking bead (16) running concentrically about the rotational axis (11).

According to a general aspect, it is provided that mass is removed by means of an ellipsoidal material-removal tool at mass-removal positions next to the marking bead (16) in the hub rear wall (15) of the turbine wheel (10) of an exhaust gas turbine.

The mass is removed at the mass-removal positions by a relative movement of an ellipsoidal material-removal tool and the hub rear wall (15). The ellipsoidal material-removal tool may be moved and the hub rear wall (15) remain stationary, or the hub rear wall (15) may be moved and the ellipsoidal material-removal tool remain stationary, or a simultaneous movement may take place of the ellipsoidal material-removal tool and the hub wall (15), or any combination thereof. Preferably, the ellipsoidal material-removal tool is moved at least in the depth direction. The marking bead (16) is particularly advantageous if the ellipsoidal material-removal tool is a freely movable tool and is held and guided e.g. by a human hand.

For any type and combination of relative movement of the ellipsoidal material-removal tool and hub rear wall (15), the (relative) movement of the material-removal tool is oriented at the marking bead (16) arranged on the hub rear wall (15) of the turbine wheel (10).

The mass is removed at mass-removal positions in the hub rear wall (15) for balancing a turbine wheel (10) of an exhaust gas turbine by production of a mass-removal indentation (13), asymmetric relative to the rotational axis (11), by means of the ellipsoidal material-removal tool. The position(s) of the mass-removal indentation(s) (13) is (are) oriented relatively next to the marking bead (16), wherein the marking bead (16) is left intact. The most protruding part of the marking bead (16) containing the apex of the marking bead thus remains untouched and unmachined.

The ellipsoidal material-removal tool has a tool machining geometry configured in the form of an ellipsoid. The tool thus has an ellipsoidally formed material-removal tool head for removing material from the hub rear wall in an ellipsoid segment. The ellipsoid describing the tool machining geometry is defined by the three semi-axes H, B and Y. H and B represent the semi-axes shown in FIG. 3 of the resulting cross-sectional contour of the mass-removal indentation (13), and Y is the further semi-axis running perpendicularly to these two semi-axes (and hence to the drawing plane in FIG. 5) of the ellipsoid describing the tool machining geometry. With a rotating tool head, the two semi-axes running perpendicularly about the rotational axis R are preferably equal, i.e. with an axially rotating tool head, Y=H; for a radially rotating tool head, Y=B.

In one embodiment of the ellipsoidal material-removal tool, the ellipsoid describing the tool machining geometry has a configuration in which at least two of the three semi-axes H, B, Y have the same longitudinal extent. In a further embodiment of the ellipsoidal material-removal tool, the ellipsoid describing the tool machining geometry has a configuration in which all three semi-axes H, B, Y have the same longitudinal extent. According to one aspect, the tool may have a rotating tool head with an elliptical form corresponding to the tool machining geometry. If the tool head rotates, the rotational axis is preferably one of the semi-axes, and at least the other two semi-axes are the same.

If all three semi-axes H, B, Y have the same longitudinal extent, the tool machining geometry is a ball, i.e. it is a spherical material-removal tool (e.g. a tool with spherical head). Such a spherical material-removal tool has the advantage that the angular orientation of the tool relative to the hub rear wall is not important, at least within an angular range, which facilitates handling of the tool-in particular for a freely movable tool.

The ellipsoidal material-removal tool may be any tool able to machine by material removal. Typically, but not limited thereto, these are turning tools, drilling tools, countersink tools, friction tools, milling tools, planing tools, slotting tools, broaching tools, sawing tools, filing tools, rasping tools, brush grinding tools, scraping tools, chiseling tools, grinding tools (with or without rotating tool), belt sanding tools, honing tools, lapping tools or sliding machining tools.

In one embodiment, the ellipsoidal material-removal tool is a grinding tool with ellipsoidal grinding head, e.g. a spherical grinding tool with spherical grinding head.

According to one aspect, the mass-removal indentation (13) is produced by an ellipsoidal material-removal tool in the hub rear wall (15) of a turbine wheel of an exhaust gas turbine. According to one aspect, machining takes place along a circle sector of the hub rear wall (15) and in the circumferential direction along a circle arc about the axis (11). Preferably, machining takes place within a ring segment or circle segment along an arc. According to a further aspect, machining may take place along any one-dimensional profile on the hub rear wall (15) of a turbine wheel (10).

According to one aspect, the mass-removal indentation (13) may be provided as a continuous circle segment, as illustrated for example in FIG. 1. More generally, the mass-removal indentation (13) may be provided as a continuous, segment-like, interrupted or discrete spot machining along a circle arc. The arc along which the relative movement of the ellipsoidal material-removal tool and hub rear wall (15) takes place is oriented to the marking bead (16) in the hub rear wall (15) such that the arc runs next to the marking bead (16) in the hub rear wall (15).

According to one aspect, the method comprises firstly determining an imbalance of the turbine wheel (10). Depending on the determined imbalance of the turbine wheel (10), a material-removal profile for the mass-removal indentation (13) is produced. This material-removal profile may be a one-dimensional profile along a circle segment of the hub rear wall (15) and run along an arc to the marking bead (16) in the hub rear wall (15). The material-removal profile indicates how the material should be removed. Possible embodiments comprise a continuous, segment-like, interrupted and/or discrete spot material-removal profile. Any profiles with a (continuous or discrete) angle-dependent penetration depth may be used. According to one aspect, the profile is limited by a maximum angular range and/or a maximum penetration depth. According to a further aspect, the material-removal profile for the mass-removal indentation (13) may also be produced without prior determination of an imbalance of the turbine wheel (10).

According to one embodiment, the material-removal profile may for example comprise an (annular) middle position on the hub rear wall (15), an angular region along the arc, a longitudinal extent along the arc of the mass-removal indentation (13), and/or the (constant or angle-dependent) material-removal depth C. In particular, a material-removal depth C which varies over the respective angular region may be established for the mass-removal indentation (13) and thus for example run-outs produced. Also, in this way, a material-removal profile for multiple mass-removal indentations (13) may be provided.

With the material-removal profile provided, the mass-removal indentation (13) is made in the hub rear wall (15) of a turbine wheel of an exhaust gas turbine. According to one aspect, the imbalance of the turbine wheel is reduced by the production of the mass-removal indentation (13).

In order to produce the mass-removal indentation (13) in optimum fashion, according to one aspect a removal-free hub test geometry is defined. The removal-free hub test geometry is a configuration of the hub (12), in particular the hub rear wall (15), without any material removal in the hub rear wall (15).

According to a further aspect (e.g. as a further hub test geometry), a maximally removed hub test geometry may be defined as the hub test geometry for the maximum permitted material removal in the hub rear wall (15). The maximum permitted material removal in the hub rear wall (15) is predefined e.g. from conditions such as typically required removal, minimum permitted remaining hub wall thickness at the material-removal positions, production processes and production possibilities at the material-removal positions, and/or structural-mechanical requirements for the material-removal position.

According to one aspect, a first hub quality parameter is calculated from the maximally removed hub test geometry, i.e. taking into account the maximum permitted material removal in the hub rear wall (15). Preferably, the hub geometry is optimized by optimizing a hub optimization variable determined using the first hub quality parameter.

According to one aspect, a second hub quality parameter is calculated from the removal-free hub test geometry, i.e. without taking into account the maximum permitted material removal in the hub rear wall (15). Preferably, the hub optimization variable is then further determined using the second hub quality parameter, e.g. by summing of respective summands determined using the first or second hub quality parameters.

The (first or second) hub quality parameter may for example contain at least one parameter selected from the following list: mechanical stress, mechanical main stress, mechanical normal stress, mechanical shear stress, a mechanical cycle-optimization variable, in particular a cycle-fatigue factor (e.g. simulated cycle capacity for fatigue at low cycles), a notched bar impact factor, a form factor, a support number, a force flow, a geometric design of the mass-removal indentation (13), a deviation from a predefined target total removal. The hub optimization variable may for example include a standard (e.g. L2 standard, i.e. square) of such a parameter, or the possibly weighted sum of such standards for multiple parameters. In particular, the hub optimization variable may thus penalize an increase in the simulated cycle capacity for low-cycle fatigue for the removal-free and/or maximally removed hub test geometry.

The optimization is preferably performed iteratively. Preferably, the parameters defining the hub test geometry are changed iteratively in order to reach an optimum of the hub optimization variable.

According to one aspect, the shape of the maximum permitted material removal may be optimized if parameters which define the maximum permitted material removal are changed iteratively. The hub optimization variable may in this case also contain a term which ensures a sufficiently large maximum permitted material removal, or a term which penalizes a deviation from a predefined total target removal.

The hub rear wall geometry is optimized with at least one parameter cited as a hub quality parameter.

Preferably, the hub geometry optimization is a multifactorial optimization in which more than one hub quality parameter is used. Preferably, the hub geometry is optimized by optimizing a hub optimization variable determined using multiple hub quality parameters. The optimization is preferably performed iteratively. Preferably, the material removals from the hub test geometry are changed iteratively, and consequently several hub quality parameters are calculated and compared with pre-existing similar hub quality parameters. Comparison of hub quality parameters and optimization may take place with any form of mathematical optimization procedure suitable for this. The iterative changing of the material removals from the hub test geometry is limited by a hub test geometry with no material removals, and by a hub test geometry with maximum permitted material removals.

Further aspects of a turbine wheel (10) for or of an exhaust gas turbine, produced using the described method, are now described below. The turbine wheel (10) is mounted rotatably and rotates about its rotational axis (11). The turbine wheel (10) has a hub (12) and a plurality of turbine blades attached to the hub (12) and arranged in the fluid flow region (14). The hub (12) also has a hub rear wall (15) facing away from the fluid flow region (14). The hub rear wall (15) contains a mass-removal indentation (13), asymmetric with respect to the rotational axis (11), for balancing the turbine wheel (10). The mass-removal indentation (13) is formed as a concave depression in the hub rear wall (15) with a cross-sectional contour of the mass-removal indentation (13) in the form of an ellipse segment. The cross-sectional contour of the mass-removal indentation (13) is defined in a cross-sectional plane Z-Z containing the rotational axis (11). The hub rear wall (15) also has a marking bead (16) running concentrically about the rotational axis (11), wherein the marking bead (16) and mass-removal indentation (13) are adjacent without radially overlapping. In other words, the mass-removal indentation (13) does not overlap the peak of the marking bead (16), and the peak therefore runs continuously around in the circumferential direction of the hub rear wall.

The mass-removal indentation (13) according to one aspect has a cross-sectional contour in a cross-sectional plane Z-Z containing the rotational axis (11). The cross-sectional contour is ellipsoidal, i.e. formed by an ellipse segment. The ellipse describing this ellipse segment is defined by a first (e.g. large) semi-axis H and a second (e.g. small) semi-axis B of the ellipse. The first semi-axis H may extend in the radial direction and the second semi-axis B of the ellipse may extend in the axial direction. Preferably, the first semi-axis H and the second semi-axis B of the ellipse have the same longitudinal extent, whereby a cross-sectional contour in the cross-sectional plane Z-Z containing the rotational axis (11) has a geometric form of a circle segment.

Preferably, a definition given herein for the cross-sectional contour applies to a plurality of cross-sectional planes Z-Z containing the rotational axis (11) and a part of the mass-removal indentation (13), particularly preferably to any such cross-sectional plane at least in a continuous angular region which covers at least half or even at least 80% of the total angular region of the mass-removal indentation (13). In the case of multiple mass-removal indentations (13), a definition given herein preferably applies to all mass-removal indentations (13).

The cross-sectional contour of the mass-removal indentation (13) according to one aspect has a minimum curvature radius Krₘᵢₙ. The minimum curvature radius of the fundamental ellipse may be estimated by the ratio Keₘᵢₙ=((B*B)/H), wherein H is the large (here: first) semi-axis of the ellipse, B the small (here: second) semi-axis of the ellipse. The curvature radius should typically fulfil a ratio of Krₘᵢₙ/F≥0.03 and/or Keₘᵢₙ/F≥0.03, wherein F is the diameter of the turbine wheel (10). When the large semi-axis H and the small semi-axis B of the ellipse have the same length, and hence there is a circular (i.e. circle segment-shaped) cross-sectional contour, consequently R/F≥0.03, wherein R is the radius of the circular cross-sectional contour. When the large semi-axis H and the small semi-axis B of the ellipse have the same length, the large semi-axis H and small semi-axis B correspond to one another and also the large semi-axis H and the small semi-axis B correspond to the radius R of the circular cross-sectional contour.

According to one aspect, the mass-removal indentation (13) has a penetration depth C of C>0 and/or C<0.6*B, preferably C<0.5*B, and particularly preferably C<0.4*B, wherein B is the second (axial and/or small) semi-axis of the ellipse.

The mass-removal indentation (13) is located in the hub rear wall (15) of the turbine wheel (10) and next to the marking bead (16) also present in the hub rear wall (15). The mass-removal indentation (13) and/or the marking bead (16) according to one aspect may be made at any circumferential position and radial position in the hub rear wall (15), wherein the two stand next to one another, i.e. with no further functional surface features in between.

Preferably, the mass-removal indentation (13) and/or the marking bead (16) are made in the radially outer half of the hub rear wall (15) (relative to the diameter F), preferably at least partly in the radially outer third. Preferably, the mass-removal indentation (13) is positioned (completely) radially outside the marking bead (16). According to one aspect, the region of the hub rear wall (15) within the marking bead (16) has no mass-removal indentation (13) and/or is completely rotationally symmetrical. According to one aspect, the marking bead (16) allows marking of a region for the mass-removal indentation (13) (namely e.g. radially outside the marking bead (16)), and/or ensures marking of a region not provided for the mass-removal indentation (13) (namely e.g. radially inside the marking bead (16)). Because of the marking bead (16), it can be ensured and easily checked that the mass-removal indentation (13) is made only in the provided region or not outside this region. This is useful in particular if the hub rear wall geometry has been optimized for the mass-removal indentation (13) provided therein.

To produce the mass-removal indentation (13), according to one aspect any tool may be used which is able to remove material. Typically but not limited thereto, these are turning tools, drilling tools, countersink tools, friction tools, milling tools, planing tools, slotting tools, broaching tools, sawing tools, filing tools, rasping tools, brush grinding tools, scraping tools, chiseling tools, grinding tools (with or without rotating tool), belt sanding tools, honing tools, lapping tools or sliding machining tools.

Preferably, the material-removal tool is a grinding tool with ellipsoidal grinding head. Typically, this grinding tool has a spherical grinding head and is consequently a spherical grinding tool with spherical grinding head. The material-removal tool with ellipsoidal grinding head may also be formed such that only the part of the material-removal tool which is in contact with the turbine wheel (10) during production of the mass-removal indentations (13) has an ellipsoidal form.

According to one aspect, the mass-removal indentation (13) for balancing a turbine wheel (10) of an exhaust gas turbine is made within a circle sector of the hub rear wall (15) of the turbine wheel (10) of an exhaust gas turbine, and along an arc in the circumferential direction. Preferably, machining is carried out within a ring segment or circle segment along an arc. Examples include, without limitation, a continuous, segment-like, interrupted or discrete spot machining along the arc.

The hub rear wall (15) of the turbine wheel (10) of an exhaust gas turbine has a marking bead (16), wherein this marking bead (16) is rotationally symmetrical to the rotational axis (11) and runs concentrically about the rotational axis (11).

The marking bead (16) in the hub rear wall (15), according to one aspect, has a cross-sectional contour which is situated in a cross-sectional plane Z-Z containing the rotational axis (11). The cross-sectional contour of the marking bead (16) is convex and raised relative to the hub rear wall (15).

According to one aspect, the marking bead (16) is radially spaced by a distance D from the mass-removal indentation (13) also contained in the hub rear wall (15) of a turbine wheel (10) of an exhaust gas turbine. Preferably, E=A+D and E≤(F−G)/2 and G/F≥0.5, wherein A is the radial extent of the mass-removal indentation (13) (radial distance between the radially inner limit of the mass-removal indentation (13) and the radially outer limit of the mass-removal indentation (13)), D is the radial distance between the marking bead (16) and the radially closer (here: radially inner) limit of the mass-removal indentation (13), E is the radial extent between the marking bead (16) and the radially further (here: radially outer) limit of the mass-removal indentation (13), F is the diameter of the rear wall of a turbine wheel (10) of exhaust gas turbine, and G is the diameter of the marking bead (16), i.e. the diameter of the circle defined by the circumferential marking bead (16) on the hub rear wall (15). Here, unless specified otherwise, the radial position of marking bead is always defined by its peak. In the case of multiple mass-removal indentations (13), an individual radial distance D from the marking bead (16) may be determined and applied for each mass-removal indentation (13). Typically, a same radial distance D is selected and applied to all mass-removal indentations (13). The minimum radial distance D between the mass-removal indentation (13) and the marking bead (16) is preferably 0<D<0.05*F, particularly preferably 0<D<0.025*F.

According to one aspect, the (preferably rotationally symmetrical) cross-sectional contour of the marking bead (16) has an apex, a radially inner flank relative to the apex and a radially outer flank relative to the apex. The radially inner flank has a concave curvature radius M, the radially outer flank has a concave curvature radius K, and the apex has a convex curvature radius L. If the curvature radius is not constant, these variables each describe the smallest curvature radius. In other words, K indicates the (smallest) curvature radius of the transition between the apex of the marking bead (16) and the radially inner limit of the mass-removal indentation (13), L is the (smallest) curvature radius at the apex of the marking bead (16), and M is the (smallest) curvature radius of the transition from the apex of the marking bead (16) to the region of the hub rear wall (15) lying radially inside the marking bead (16). According to one aspect, K>0, L≥0, and/or M>0. Furthermore, preferably K/F<0.07, M/F<0.07,L/K<0.15, and/or L/M<0.1.

According to one aspect, the surface of the hub rear wall (15) in the entire radial region, at least from the radius of the marking bead (16) to the outermost radius of the mass-removal indentation (13), is a machined surface, i.e. has a higher smoothness and precision than a surface obtained directly by casting for example.

The marking bead (16) in the hub rear wall (15) of a turbine wheel (10) of an exhaust gas turbine may be made at any radial position. Preferably, the marking bead (16) is situated radially inside the mass-removal indentation (13).

According to one aspect, the imbalance of the turbine wheel is smaller than the imbalance of the corresponding (theoretical) turbine wheel with rotationally symmetrical hub without mass-removal indentation (13). According to one aspect, the low-cycle fatigue capacity of the turbine wheel is not smaller, or is at most 2% smaller, than the cycle capacity of a corresponding (theoretical) turbine wheel with rotationally symmetrical hub without mass-removal indentation (13).

All above-mentioned aspects for a turbine wheel (10) of an exhaust gas turbine concern exhaust gas turbines of any design, preferably radial exhaust gas turbines or mixed-flow exhaust gas turbines (also called diagonal exhaust gas turbines). In radial exhaust gas turbines, the turbine wheel (10) is configured as a radial turbine wheel. In mixed-flow exhaust gas turbines, the turbine wheel (10) is configured as a mixed-flow (diagonal) exhaust gas turbine wheel, i.e. with a hub front wall of which the inlet tangent runs in a diagonal direction with both axial and radial components.

According to one aspect, the exhaust gas turbine is configured to be driven by exhaust gas from an internal combustion engine. According to one aspect, the exhaust gas turbine is provided for a turbocharger. In a turbocharger, the exhaust gas turbine drives a compressor wheel arranged on a common shaft in order to increase pressure, density and enthalpy of an aspirated fluid, and hence increase the charge pressure and generally the efficiency of the internal combustion engine. Alternatively or additionally, the exhaust gas turbine may also drive other energy users, e.g. an electrical generator and/or a drive shaft. According to one aspect, an internal combustion engine is provided, with the exhaust gas turbine driven by exhaust gas from the internal combustion engine, and a turbocharger with the exhaust gas turbine.

In a further aspect of the invention, an exhaust gas turbine is provided with a turbine wheel (10) which fulfils any feature of the second aspect of the invention. The exhaust gas turbine may be driven by any type of exhaust gas. Furthermore, all designs of exhaust gas turbine, such as radial exhaust gas turbines or mixed-flow exhaust gas turbines, may be considered. Also, all possible consumers on the exhaust gas turbine shaft, such as e.g. compressor wheels, electrical generators or drive shafts, may be considered. Preferably, the exhaust gas turbine is an exhaust gas turbocharger.

### LIST OF REFERENCE SIGNS

10 Turbine wheel of an exhaust gas turbine.
11 Rotational axis of a turbine wheel of an exhaust gas turbine.
12 Hub of a turbine wheel of an exhaust gas turbine.
13 Mass-removal indentation.
14 Fluid flow region of a turbine wheel of an exhaust gas turbine.
15 Hub rear wall of a turbine wheel of an exhaust gas turbine.
16 Marking bead.
20 Ellipsoidal material-removal tool.
A Radial extent of ellipsoidal mass-removal indentation from radially inner limit of the ellipsoidal mass-removal indentation to radially outer limit of the ellipsoidal mass-removal indentation.
B Second (small) semi-axis of ellipsoidal mass-removal indentation.
C Material-removal depth.
D Radial distance from marking bead to radially inner limit of the ellipsoidal mass-removal indentation.

E Radial distance from marking bead to radially outer limit of the ellipsoidal mass-removal indentation.
F Diameter of rear wall of a turbine wheel of an exhaust gas turbine.
G Diameter of marking bead.
H First (large) semi-axis of ellipsoidal mass-removal indentation.
K Curvature radius of transition between apex of marking bead and radially inner limit of mass-removal indentation.
L Curvature radius at apex of marking bead.
M Curvature radius of transition from apex of marking bead to hub rear wall radially inside the marking bead.
X Detail view of FIG. 2 with enlarged illustration of marking bead.
Y Third semi-axis of ellipsoid defining the tool machining head.
Z-Z Section in a turbine wheel of an exhaust gas turbine containing the rotational axis.

1. A method for balancing a turbine wheel (10) for an exhaust gas turbine, wherein the turbine wheel (10) is rotatable about its rotational axis (11) and has a hub (12) and a plurality of turbine blades attached to the hub (12) and arranged in a fluid flow region (14), wherein the hub has a hub rear wall (15) facing away from the fluid flow region (14) with a marking bead (16) running concentrically about the rotational axis (11), the method comprising:
movement of an ellipsoidal material-removal tool relative to the turbine wheel (10) at a mass-removal position next to the marking bead (16);
creation of a mass-removal indentation (13), asymmetric relative to the rotational axis (11), in the hub rear wall (15) for balancing the turbine wheel (10) by removal, by means of the material-removal tool, of hub material of the hub rear wall (15), next to the marking bead (16) and leaving the marking bead (16) intact.

2. The method for production of a turbine wheel (10) for an exhaust gas turbine as claimed in claim 1, wherein the material-removal tool is a grinding tool with ellipsoidal grinding head, preferably a spherical grinding tool with spherical grinding head.

3. The method as claimed in any of the preceding claims, wherein the mass-removal indentation (13) is made along a ring segment in the circumferential direction about the rotational axis (11).

4. The method as claimed in any of the preceding claims, furthermore comprising:
determination of an imbalance of the turbine wheel;
depending on the determined imbalance, setting of a material-removal profile for the mass-removal indentation (13); and
creation of the mass-removal indentation (13) with the set material-removal profile.

5. The method as claimed in any of the preceding claims, furthermore comprising:
definition of a removal-free hub test geometry; and
calculation of a first hub quality parameter using a maximally removed hub test geometry as the defined removal-free hub test geometry, minus a maximum removal quantity from the hub rear wall of the removal-free hub test geometry;
preferably optimization of the hub geometry by optimization of a hub optimization variable, calculated using the first hub quality parameter, by iterative changing of a hub test geometry between removal-free and maximally removed hub test geometry,
wherein the removal of hub material at the hub rear wall (15) is limited by the maximum removal quantity.

6. The method as claimed in claim 5, wherein the hub quality parameter comprises at least one parameter selected from the following list: a mechanical stress, a mechanical cycle optimization variable, a cycle fatigue indicator.

7. The method as claimed in claim 5 or 6, furthermore comprising:
calculation of a second hub quality parameter using the defined hub test geometry without removal of hub rear wall material from the hub test geometry;
preferably, optimization of the hub geometry by optimization of a hub optimization variable, calculated using the first and second hub quality parameters, by iterative changing of a hub test geometry between removal-free and maximally removed hub test geometry.

8. A turbine wheel (10) for an exhaust gas turbine, wherein the turbine wheel (10) is rotatable about its rotational axis (11) and has
a hub (12); and
a plurality of turbine blades attached to the hub (12) and arranged in a fluid flow region (14), wherein the hub has a hub rear wall (15) facing away from the fluid flow region (14), wherein
a mass-removal indentation (13), asymmetric relative to the rotational axis (11), is provided in the hub rear wall (15) for balancing the turbine wheel (10), wherein the mass-removal indentation (13) is configured as a concave depression in the hub rear wall (15) with a cross-sectional contour in the form of an ellipse segment, wherein the cross-sectional contour of the mass-removal indentation (13) is defined in a cross-sectional plane (Z-Z) containing the rotational axis (11), wherein
the hub rear wall (15) furthermore has a marking bead (16) running concentrically to the rotational axis (11), wherein the marking bead (16) and the mass-removal indentation (13) are adjacent to one another without radially overlapping.

9. The turbine wheel (10) as claimed in claim 8, wherein the mass-removal indentation (13) has at least one of the following properties (a) to (g):
(a) the cross-sectional contour of the mass-removal indentation (13) has the form of a circle segment;
(b) the cross-sectional contour of the mass-removal indentation (13) has a minimum curvature radius of more than 0.03*F, wherein F is the diameter of the rear wall of the turbine wheel (10);
(c) the cross-sectional contour of the mass-removal indentation (13) fulfils the condition ((B*B)/H)/F>0.03, wherein H is the large semi-axis of the elliptical cross-sectional contour of the mass-removal indentation (13), B is the small semi-axis of the elliptical cross-sectional contour of the mass-removal indentation (13), and F is the diameter of the rear wall of the turbine wheel (10);
(d) the mass-removal indentation (13) is arranged at least partially in the radially outer half of the hub rear wall (15);
(e) the mass-removal indentation (13) is produced by means of a material-removal tool, preferably a grinding tool;
(f) the mass-removal indentation (13) extends along a ring segment running circumferentially around the axis;
(g) the mass-removal indentation (13) extends as a continuous line, as a sequence of portions of continuous lines, or as a sequence of discrete spot indentations.

10. The turbine wheel (10) as claimed in claim 8 or 9, wherein the marking bead (16) has at least one of the following properties (i) to (iv):
(i) the marking bead (16) is raised and convex in the cross-sectional plane;
(ii) the marking bead (16) is rotationally symmetrical relative to the rotational axis (11);
(iii) the marking bead (16) is arranged according to the inequation E≤(F−G)/2 and/or G/F>0.5, wherein A is the radial extent of the mass-removal indentation (13) from a radially inner end of the mass-removal indentation (13) to a radially outer end of the mass-removal indentation (13), D is the radial distance of the apex of the marking bead (16) from the mass-removal indentation (13), E=A+D is the radial distance of the apex of the marking bead (16) from the radially outer limit of the mass-removal indentation (13), F is the diameter of the turbine wheel (10), and G is the diameter of the circle defined by the apex of the marking bead (16);
(iv) the marking bead (16) is arranged radially inside the mass-removal indentation (13).

11. The turbine wheel (10) as claimed in any of claims 8 to 10, wherein the turbine wheel is a radial turbine wheel for a radial exhaust gas turbine, or a mixed-flow turbine wheel for a mixed-flow exhaust gas turbine.

12. An exhaust gas turbine, preferably an exhaust gas turbocharger, with a turbine wheel (10) as claimed in any of claims 8 to 11.
